(19) United States
(12) Patent Application Publication
(10) Pub. No.: US 2002/0076580 A1
(43) Pub. Date: Jun. 20, 2002

(54) Interlocking cell constructions

(76) Inventor: Frank B. Tudron, Westlake, OH (US)

Correspondence Address: ROBERT W WELSH, EVEREADY BATTERY COMPANY INC, 25225 DETROIT ROAD, P O BOX 450777, WESTLAKE, OH, 44145

(21) Appl. No.: 09/737,446

(22) Filed: Dec. 14, 2000

(51) Int. Cl. H01M 2/10

(52) U.S. Cl. 429/1; 429/97; 429/99

(57) ABSTRACT

A battery cell that can be combined with one or more identical cells in a stacked arrangement in which the cells are electrically connected in either series or in parallel includes a housing having integral connectors facilitating releasable attachment of the battery cell to an identical battery cell. In one embodiment, the battery cell is provided with a plurality of positive terminals and a plurality of negative terminals, whereby stacking of the batteries in either of two different orientations is facilitated to achieve either a parallel electrical connection or a series electrical connection.

### FIELD OF THE INVENTION

This invention relates to battery cells, and more particularly to battery cells having features facilitating stacking of battery cells in either parallel or serial arrangements.

### BACKGROUND OF THE INVENTION

Conventional cells used for electrical appliances such as radios, flashlights, etc. typically have a cylindrical shape, and are formed with one positive electrode terminal at one end and one negative electrode terminal at the other end. A plurality of cells can be arranged and connected end-to-end in series to obtain a desired voltage to power an electrical appliance or device. Depending on the size and shape of the electrical device and the power requirements of the electrical device, it may be necessary to arrange a plurality of battery cells in series, with the individual cells disposed end-to-end and side-by-side, with a bridging contact extending between the end most side-by-side cells to connect such cells in series. Electrical contacts or leads are connected to opposite ends of the series connected cells to provide electrical power to the device.

It is also common to arrange battery cells in parallel, when increased capacity is desired. Also, a combination of series connections and parallel connections can be made to achieve a desired voltage and capacity.

Replacement of batteries for electronic devices using a conventional stacking arrangement of cylindrical batteries to achieve a desired cumulative voltage (series stacking) and/or a desired cumulative capacity (parallel stacking) generally involves removing each of the batteries, and replacing each of the batteries individually. Depending on the battery stacking configuration and the configuration of the battery compartment of the electronic device, battery replacement can be difficult and time consuming.

In an attempt to overcome these disadvantages, battery packs have been employed. A first type of battery pack comprises a plurality of battery cells that are electrically connected as desired in parallel and/or series, physical arranged in a predetermined shape or configuration, provided with appropriate electrical leads, and permanently encased or packaged for use in a particular device. The individual battery cells are not accessible and cannot be arranged as desired to accommodate different voltage requirements, capacity requirements, or battery compartment configurations. These types of battery packs have been employed in certain specialized applications (e.g., cordless telephones and radio-controlled toy vehicles). However, for most general purpose electronic devices, such as flashlights, portable radios, portable recording devices, compact disc players, etc., it is desirable to use a plurality of standard size battery cells that can be arranged, both electrically and physically, as desired, rather than using a highly specialized battery pack configuration that many retailers will not keep in stock.

Another type of battery pack that has been employed incorporates a reusable housing designed to contain a plurality of standard size battery cells in a desired configuration. Such battery packs usually have some type of physical connector or latching structure for attaching the battery pack to an electronic device, as well as electrical connections that contact electrical connectors on the electronic device. This type of battery pack allows quick changing of batteries and uses readily available standard size battery cells. A disadvantage with this type of battery pack arrangement is that it is relatively bulky as compared with integrating a battery compartment into the electrical device. As a result these reusable battery packs employing highly available standard size battery cells have only been used in limited applications, such as a back-up power source for portable video camera recorders.

### SUMMARY OF THE INVENTION

The invention provides a standard battery cell that can be combined with one or more identical cells in a stacked arrangement in which the cells are electrically connected in series and/or in parallel, depending on the orientation of the cells in the stacked arrangement.

In accordance with one aspect of the invention, a battery cell is provided with a housing having integral connectors facilitating releasable attachment of the battery cell to an identical battery cell.

In accordance with another aspect of the invention, a battery cell is provided with a plurality of positive terminals and a plurality of negative terminals, whereby stacking of the batteries in either of two different orientations is facilitated to achieve either a parallel electrical connection or a series electrical connection.

In a preferred embodiment, there is provided a battery cell having a housing with an integral connector for releasably attaching the battery cell to an identical battery cell in either of two different orientations, a plurality of positive terminals, and a plurality of negative terminals, whereby two identical battery cells can be electrically connected in parallel or in series, as desired, depending on the orientation of the two battery cells with respect to each other.

These and other features, advantages and objects of the present invention will be further understood and appreciated by those skilled in the art by reference to the following specification, claims and drawings.

### BRIEF DESCRIPTION OF THE DRAWINGS

FIG. 1 is a perspective illustration of a plurality of batteries in accordance with the invention physically arranged in a stack to achieve a series electrical connection;

FIG. 2 is a perspective illustration of a plurality of batteries in accordance with the invention physically arranged in a stack to achieve a parallel electrical connection.

### DESCRIPTION OF THE PREFERRED EMBODIMENTS

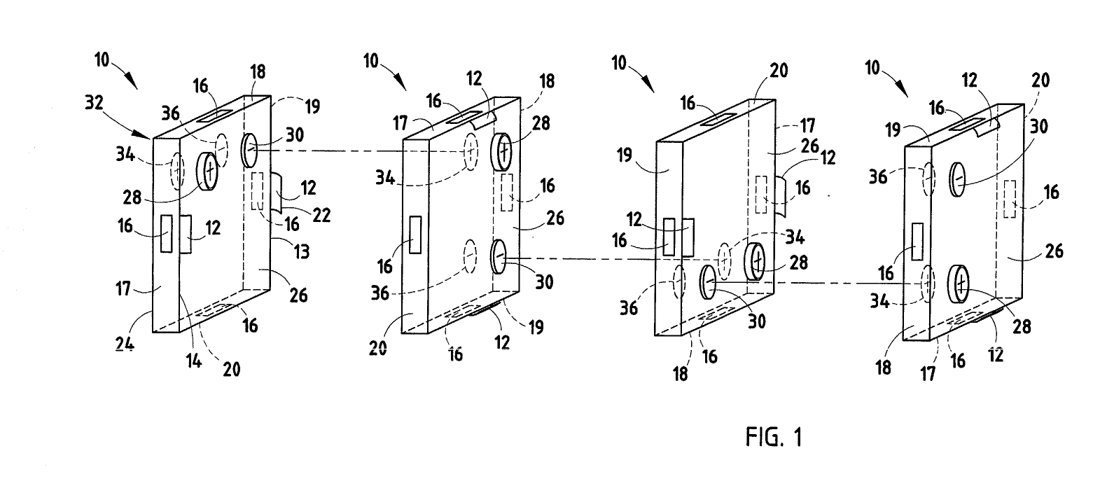

In FIG. 1, there is shown a schematic representation of a plurality of battery cells 10 in accordance with the invention arranged electrically in series, i.e., physically arranged so that a positive terminal of one battery is electrically connected with a negative terminal of an adjacent battery whereby the voltage output from a positive terminal at one end of the stack and a negative terminal at the other end of the stack is equal to the product of the unit voltage of each cell 10 in the stack times the number of cells 10 in the stack.

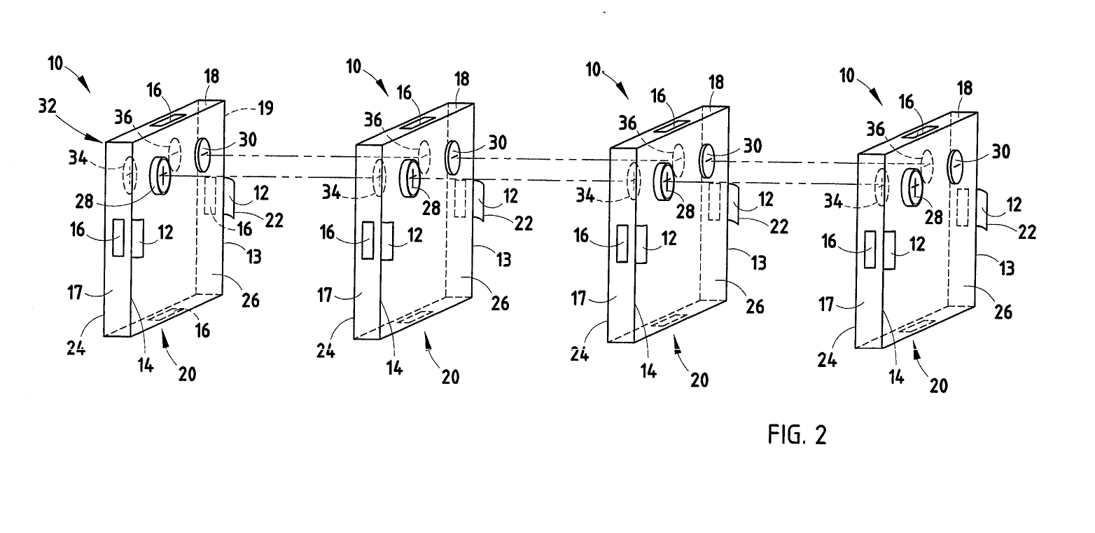

FIG. 2 shows an alternative arrangement in which the same stack of batteries is physically arranged to achieve a parallel electrical connection between the cells 10, i.e., an arrangement in which a positive terminal on each battery is connected to a positive terminal on an adjacent battery, and a negative terminal on each battery is electrically connected to a negative terminal on an adjacent battery, whereby the total capacity of the cells arranged in the stack is equal to the sum of the capacities of the individual cells.

Each battery cell 10 includes an integral connector or connectors for releasably attaching the battery cell 10 to an identical battery cell. In the illustrated embodiment, each battery cell 10 includes a pair of connector clips 12 that project from opposite edges 13, 14 of battery cell 10 and resiliently engage a recess 16, one of which is located on each of the sides 17, 18, 19 and 20. More specifically, each of connector clips 12 is elastically deformable so that the distal ends 22 of clips 12 protrude into recesses 16, whereby each of battery cells 10 can be releasably attached to an adjacent battery cell. The integral connectors can be either integrally formed as part of the housing 24 or fixed to the battery housing. Various alternative types of connectors may be used, such as snap-type connectors, hook and loop type connectors, etc. A single connector or a plurality of connectors may be used. However, in accordance with a preferred aspect of the invention, the connector or connectors on each battery cell 10 are capable of allowing the battery cell to be connect to another identical battery cell in any of at least two alternative orientations to achieve either a parallel electrical connection between the batteries, or a series electrical connection between the batteries.

Although it is contemplated that various electrical contact arrangements may be used for achieving the desired ability to connect the batteries either in series or in parallel, a preferred electrical terminal arrangement is shown in the illustrated embodiment. A front face 26 of battery cell 10 includes one positive terminal 28 and one negative terminal 30, and a rear face of 32 of battery cell 10 includes one positive terminal 34 and one negative terminal 36. In the illustrated embodiment, the positive terminals 28 and 34 on the front and rear faces, respectively, are in alignment, and the negative terminals 30 and 36 on the front face 26 and rear face 32, respectively, are in alignment. Terminals 28 and 30 are located at adjacent corners of a hypothetical square centered within square front face 26, and terminals 34 and 36 are located at adjacent corners of an identical hypothetical square centered within square rear face 32. This arrangement allows each battery cell 10 in a stack to be rotated 90° with respect to an adjacent member in the stack whereby a positive terminal on the rear face of each member in the stack (except for the rear member) is electrically connected with a negative terminal on the front face of an adjacent member, while the negative terminal on the rear face and the positive terminal on the front face of each cell is not connected with a terminal on an adjacent cell. The illustrated terminal placement also allows the positive terminal on the rear face of each cell to be electrically connected with the positive terminal on the front face of an adjacent cell (except for the front cell in the stack), and the negative terminal on the rear face of each cell to be connected with the negative terminal on the front face of an adjacent cell (except for the front cell), to achieve parallel electrical connections between the cells when each of the cells is in an identical orientation, as shown in FIG. 2.

The positive terminals 28 and 34 of battery cell 10 are electrically connected together, such as by an electrically insulated electrical conductor extending internally through the battery cell, embedded in the housing, or wrapped around the outside of the housing.

In the case of the serial arrangement shown in FIG. 1, an electrical load is connected to the positive terminal 28 of the battery cell 10 on the right end of the stack and the negative terminal 36 of the battery cell on the left end of the stack. In the case of the parallel arrangement shown in FIG. 2, an electrical load may be connected to the positive terminal at either end of the stack and to the negative terminal at either end of the stack.

The ability of the battery cells of this invention to be quickly and easily connected to each other in either of at least two different orientations to provide parallel or serial electrical connections between adjacent batteries allows battery assemblies having a desired voltage and/or capacity to be pre-assembled and subsequently easily installed in a battery compartment of an electronic device. As already suggested, a combination of serial and parallel arrangements may be used. For example, two or more battery cells 10 can be connected in parallel to form a high capacity stack, which can be arranged in serial with a plurality of similar high capacity parallelly arranged stacks.

It will be apparent to those skilled in the art that various modifications and adaptations can be made to the present invention without departing from the spirit and scope of this invention. Thus, it is intended that the present invention cover the modifications and adaptations of this invention, provided they come within the scope of the appended claims and their equivalents.

What is claimed is:

1. A battery cell, comprising:
at least one electrochemical cell contained in a housing, the housing including an integral connector for releasably attaching the battery cell to an identical battery cell.

2. The battery cell of claim 1, wherein the connector is configured to allow the battery cell to be releasably attached to an identical battery cell in either of two different orientations corresponding with electrical connection of the batteries in series and electrical connection of the batteries in parallel.

3. A battery cell, comprising at least one electrochemical cell contained in a housing, and having a plurality of positive terminals and a plurality of negative terminals.

4. The electrical cell of claim 3, wherein a positive terminal is located on each of opposite faces of the battery cell, and a negative terminal is located on each of the opposite faces of the battery cell.

5. The battery cell of claim 4, wherein the plurality of positive terminals and plurality of negative terminals allow the battery cell to be electrically connected to an identical battery cell in either of two different orientations, a first orientation corresponding to a parallel electrical connection between the batteries and a second orientation corresponding to a serial electrical connection between the batteries.

6. A battery cell comprising:
at least one electrochemical cell contained in a housing, the housing including a connector for releasably attaching the battery to an identical battery in either of two different orientations, the battery including a plurality of positive terminals and a plurality of negative terminals, the positive terminals and negative terminals being located on the battery so that a positive terminal on the battery is electrically connected to a positive terminal on said identical battery and a negative terminal on the battery is electrically connected to a negative terminal on said identical battery when the battery is connected to said identical battery in a first of said two orientations, and so that a positive terminal on the battery is electrically connected to a negative terminal on said identical battery when the battery is connected to said identical battery in a second of said two orientations.
